(19) United States
(12) Patent Application Publication
(10) Pub. No.: US 2012/0006441 A1
(43) Pub. Date: Jan. 12, 2012

(54) PROTECTIVE SHEATH

(75) Inventors: Paul Anthony Cavicchiolo, Victoria (AU); Steven John Hutchison, Victoria (AU); Kon Lai, Victoria (AU); Martin Chadwick, Victoria (AU); Leigh Wayne Morrison, Victoria (AU)

(73) Assignee: AUSTRALASIAN STEEL PRODUCTS PTY LTD, Footscray, Victoria (AU)

(21) Appl. No.: 13/003,228

(22) PCT Filed: Jul. 7, 2009
(86) PCT No.: PCT/AU2009/000872

§ 371 Date: Jun. 7, 2011

(30) Foreign Application Priority Data
Jul. 7, 2008 (AU) 2008903465

(51) Int. Cl. F16L 55/00; B29C 63/02

(52) U.S. Cl. 138/103; 264/171.26

(57) ABSTRACT

The present invention relates to a protective sheath (12), a conduit assembly (11) including a protective sheath (12), and a method of forming a protective sheath (12). The protective sheath (12) has at least two layers, including: a woven layer (13); and an elastomeric layer (14); the sheath (12) being configured to locate around a length of conduit (15).

### TECHNICAL FIELD

The present invention relates generally to a protective sheath for a conduit such as, but not limited to, a hose or pipe. More particularly, the invention relates to a sheath for a conduit which can protect people or machinery from injury or damage caused by ruptured conduits, or from fluid (or other working mediums) erupting through rupture points/zones or other damaged areas which can occur when hoses, pipes or the like burst or rupture.

It is to be appreciated that the term “conduit” used herein can include any practical rigid walled pipe, flexible walled hose or other fluid carrying arrangement.

The invention is particularly applicable for use with high pressure conduits, such as high pressure flexible hoses, used in an environment using high pressure hydraulic applications. However, it is to be appreciated that the invention is not limited to that application, and could instead be used in other safety applications such as within a domestic environment, for applications using substantially rigid conduits such as pipes or rigid lines, or in low pressure applications where lower pressure fluids or other working mediums are being conveyed through flexible pipes or hoses. The invention may also be used in applications where the lower pressure working medium is a dangerous substance upon contact, such as steam or super-heated steam.

### BACKGROUND ART

The following discussion of the background of the invention is intended to facilitate an understanding of the invention. However, it should be appreciated that the discussion is not an acknowledgement or admission that any of the material referred to was published, known or part of the common general knowledge as at the priority date of the application.

Hydraulic and pneumatic control and power systems are used with a wide variety of machines and tools and in a wide variety of situations, and the integrity of conduits and conduit assemblies that convey hydraulic or pneumatic fluids in such systems is critical.

Failed conduits can cause serious damage to surrounding machinery, as well as cause injury to personnel, particularly in high pressure applications. Conduits can fail at a point which is at or proximate to a conduit coupling (or anchor). Such failures can cause a conduit to become free from the coupling while the working medium is still being supplied, and the pressure of the working medium through the failed conduit can cause the free end of the conduit to whip about violently. This can potentially cause serious damage to surrounding machinery or components, as well as any proximate personnel.

Furthermore, conduits which fail at any point along their length may splash, spray or mist fluid (and material entrained therein) onto surrounding machinery, components or personnel or, in the case of high pressure fluids, can inject fluid into a person causing serious injury or even death.

A conduit can fail or become damaged, for many reasons. Damaged conduits may be caused by problems which occur during the actual manufacturing process of the conduit, such as through material inclusions or defects. Manufacturing problems more specifically attributable to flexible conduits can cause holes (such as pin-holes) or areas of sub-standard quality or density material in the flexible conduit. Conduits can also be damaged or caused to burst or rupture through normal use (where fluid working pressures may spike or fluctuate over time), or through normal wear or fatigue to which the conduit is subjected during use.

Conduits can also be damaged by such means as accidental cutting, shearing, puncturing, tearing, splitting, abrasion occurring by repeated abrasive contact with adjacent components or surfaces, or by exposure to flames or high temperatures above which the material of the conduit is rated.

One example of a high pressure application where the integrity of such conduit assemblies is critical is the mining industry, where mining industry hoses can be used in high pressure applications which can be subject to pressures of, for example, 500 bars when fluid is static or flowing in the hose. Accordingly, when hoses used in such applications fail in a manner described above, the consequences for nearby personnel and machinery can be very serious indeed.

It would therefore be desirable to eliminate or at least reduce the damage and severity of injuries caused by a fluid or other working medium being ejected through a damaged portion of a conduit, or damage caused by a whipping conduit, when a conduit fails.

### SUMMARY OF INVENTION

According to the present invention, there is provided a protective sheath, the sheath having at least two layers including a woven layer and an elastomeric layer, wherein the sheath is configured to locate around a length of conduit.

Preferably, the woven layer of the protective sheath is seamless. A seamless woven layer can advantageously improve the strength and resistance to tearing or splitting of the protective sheath, which occurs in other seamed sheaths known to the applicant. When the woven layer is arranged as a seamless layer, the sheath can advantageously block or hinder the ejection of fluid during a conduit burst, although it should be noted that the woven layer need not be fluid tight.

The woven layer can also be made from a substantially closed-weave material (i.e. of closed or continuous form, having substantially no openings or interstices along the length of the woven layer of the sheath). It is particularly preferable for the warp and weft yarns to be arranged in a high strength, high density weave pattern. In a preferred embodiment, the woven layer has a high density weave pattern having a coverage of above about 50% to 100%, and more preferably between about 70% to 100%. In embodiments which include the woven layer as an outermost layer of the sheath, weave layers with greater amounts of coverage can advantageously provide a greater abrasive resistance than weave layers with relatively less amounts of coverage.

Alternatively, however, the woven layer can be made from a substantially open-weave material.

Sheaths having separate woven and elastomeric layers can advantageously provide improved resistance to the fluid forces subjected to the sheath from a burst or damaged conduit, as compared to single layer sheaths known to the applicant.

In a preferred embodiment, the woven layer can be fixed to the elastomeric layer in any suitable manner. For example, in some preferred embodiments the elastomeric layer is integral with the woven layer, or may alternatively be vulcanised to the woven layer.

In other preferred embodiments, the elastomeric layer is impregnated into or about the woven layer, or is alternatively bonded or adhered to the woven layer.

Hose sheaths having the elastomeric and woven layers fixed together (including through vulcanising, being integral with, bonding or adhering) can advantageously provide improved strength and therefore resistance to fluid which is ejected through a burst or damaged hose.

Alternatively, the woven layer can be separate from the elastomeric layer.

The woven and elastomeric layers can be positioned relative to one another in any suitable configuration. For example, the woven and elastomeric layers can be positioned relative to one another such that the woven layer defines an inner layer of the sheath.

Alternatively, the sheath can be arranged so that the woven and elastomeric layers are positioned relative to one another such that the elastomeric layer defines an inner layer of the sheath.

The sheath may also further include a suitable lubricant, or is at least partially slippery, on at least a portion of an inner surface of the inner layer of the sheath. This may assist in installing the sheath on a conduit of and/or conduit assembly.

A protective sheath according to the present invention can include one or more further layers. The one or more further layers can include a further woven layer, or a further elastomeric layer, or combinations thereof, depending on the particular application and characteristics of the sheath required.

In a preferred embodiment, the one or more further layers at least includes a further woven layer which is positioned relative to the woven layer and the elastomeric layer such that the further woven layer defines an outer layer of the sheath. In a particularly preferred embodiment, the woven layer and the further woven layer define both the inner layer and the outer layer of the sheath respectively. Embodiments including the woven layer and a further woven layer as the inner and outer sheath layers respectively can provide a flexible sheath, which may provide improved resistance to a conduit burst, and/or simplify installation about a conduit.

The woven layer and one or more of any further woven layers can be chemically finished with a continuous dyeing process, whereby the woven layer and the one or more of any further woven layers can be dyed with different colours, thus permitting the degree of wear of an outermost woven layer of the sheath to be indicated. This provides an added safety benefit, in that personnel have a visual indication when adjacent woven layers have been damaged through abrasion, thereby allowing the damaged sheath to be identified and replaced before the conduit actually fails.

In an alternative embodiment, the one or more further layers can at least include a further elastomeric layer which is positioned relative to the woven layer such that the further elastomeric layer defines an outer layer of the sheath. In one preferred embodiment, the elastomeric layer and the further elastomeric layer define both the inner layer and the outer layer of the sheath respectively.

Further preferably, at least one of the layers is metal reinforced. Metal reinforcement can be in the form of thin wires, or cables, or any suitable arrangement of metal reinforcement which is arranged to improve the strength of the sheath to resisting and containing the forces of any fluid which is ejected through a damaged or ruptured conduit.

The woven layer can be formed from warp and weft yarns made of a textile material, or a synthetic material. Such materials can include polyamide (e.g. NYLON®), aramid (e.g. KEVLAR®), polyester, fibreglass, silicon or a combination thereof, although the applicant recognises that other suitable high strength, flexible materials, may also be used.

The woven material may also be formed using a composite material, such as including metal reinforcing.

The thickness of the woven layer is preferably between approximately 0.3 mm and approximately 4.0 mm, and more preferably the woven layer thickness is between approximately 1.0 mm and approximately 1.5 mm. The optimum thickness, however, will depend on the application for which the protective sheath is used, and may be altered accordingly.

Preferably, the elastomeric layer is made substantially from at least one of: polyurethane, synthetic rubber, natural rubber, polytetrafluoroethylene (PTFE) (e.g. TEFLON®), fluoroelastomer (e.g. FKM, VITON®), and silicon, or a combination thereof.

The elastomeric layer can advantageously allow the sheath to flex or deform sufficiently to resist or contain the energy of any fluid or other working medium which is ejected from a damaged or ruptured conduit. The flexure or deformity of the elastomeric layer can absorb the high energy of the ejected fluid, such that the energy can be dissipated entirely within the sheath and the fluid can be deflected towards, or dispelled out of, the ends of the sheath.

The thickness of the elastomeric layer is preferably between approximately 0.1 mm and approximately 5.0 mm, and more preferably between approximately 0.3 mm and approximately 2.0 mm. However, similarly to the desired thickness of the woven layer, the optimum thickness of the elastomeric layer will also depend on the application for which the protective sheath is used, and may be altered accordingly.

The sheath may have any one or more attributes of particular benefit in certain applications. These attributes include:
a. the sheath can withstand high burst pressure, in excess of about 300 bar or more;
b. the sheath has a high abrasive resistance;
c. the sheath is rated to withstand high temperatures and/or is at least partially flame-resistant;
d. the sheath has an electrical conductivity which is substantially static-free. This is particularly advantageous for applications where anti-static componentry is mandatory for safety reasons, such as underground and/or in coal mining.

The sheath is particularly suitable for application into environments using high pressure lines, steam lines, fuel lines where splashing, misting and/or eruption of oil or fuel vapour may lead to an explosion or fire.

In a preferred embodiment, the sheath further includes one or more anchors for anchoring the sheath relative to a length of conduit in a conduit assembly. The one or more anchors may be provided in any suitable arrangement which may advantageously minimise or prevent a conduit from whipping if fluid or other working medium erupts through a rupture point/zone or damaged area of a conduit which is covered by the protective sheath according to the invention. Furthermore, the one or more anchors can be arranged to at least partially capture any fluid or other working medium which erupts through a rupture point/zone of the conduit and is directed or dispelled towards one or more ends of the sheath.

According to the present invention, there is also provided a conduit assembly, including a protective sheath according to any one of the sheath embodiments described above, the sheath being located about a length of conduit.

The sheath can be sized such that there is a gap between the sheath and the conduit. The width of the gap can be advantageously arranged such that if fluid erupts through a rupture point in the conduit, the protective sheath can dissipate the energy of the erupted fluid, and any reinforcing material contained within the conduit, such as metal wires etc, which may become exposed at the rupture point can be contained within the gap and not damage or rupture the protective sheath. Advantageously, the gap can be arranged as an annular gap.

The sheath is generally configured to have an inner diameter that is larger than an outer diameter of the conduit of the assembly. In one embodiment, the inner diameter of the sheath is about 20% or more larger than the outer diameter of the conduit of the assembly, and more preferably between about 20% to about 60% larger than the outer diameter of the conduit of the assembly. However it will depend on the specific use for which the sheath is applied. Some uses may require a greater or lesser diameter. For example, flexible hoses which are bent or do not remain static during use may require a relatively larger diameter sheath to accommodate any bending and/or movement of the hose therein.

Preferably, the sheath has a sheath length which is between about 5% to about 15% longer than the length of conduit of the assembly, and more preferably the sheath length is about 8% longer than the length of conduit. However, the preferred length of the sheath will depend on whether/how the sheath is anchored, and the particular arrangement of the conduit within the conduit assembly. Generally, the greater the coverage provided by the sheath located about the length of conduit, the greater the protection which can be provided along the length of conduit. Furthermore, when the sheath locates about a substantial proportion of, or a substantially similar length to, the length of conduit, any fluid which erupts from a rupture point/zone in the conduit can be dispelled away from the rupture point/zone and towards the ends of the protective sheath, which can minimise the chance of damage to nearby equipment or components, or any injury caused by fluid injection to personnel or otherwise.

In a preferred embodiment of the conduit assembly as described above, the conduit is arranged as a high pressure hose which is rated to any practical working pressure. In a particularly preferred embodiment, the conduit assembly according to the invention can include a conduit or hose being rated to a working pressure of about 300 bar or more.

The conduit assembly as described above can further include one or more sheath anchors which can be arranged in any suitable anchor arrangement as determined by a person skilled in the art. For example, the one or more sheath anchors can be arranged towards at least one of the end of the sheath. Alternatively, or additionally, the one or more sheath anchors may anchor the sheath to an external fixing point. The sheath can further, or alternatively, include one or more anchoring points, to which the one or more anchors can be anchored. The one or more sheath anchors can also be arranged to anchor the sheath relative to the hose of the assembly by means of crimping, clamping, heat-shrinking, circlipping, cable tying, swaging or any other suitable arrangement known to a person skilled in the art.

According to the present invention, there is also provided a method of forming a protective sheath from a woven layer and an elastomeric layer, the sheath according to any one of the sheath embodiments as described above.

### BRIEF DESCRIPTION OF DRAWINGS

The present invention will now be described with reference to the figures of the accompanying drawings, which illustrate example embodiments of the present invention, wherein:

FIG. 1 is a side-view of a hose assembly including a protective sheath according to one embodiment of the present invention, partly in cross-section;

FIG. 2 shows a cross-sectional end view of a protective sheath according to another embodiment of the invention;

FIG. 3 shows a cross-sectional end view of the protective sheath according to FIG. 1;

FIG. 4 shows a cross-sectional view of the protective sheath according to yet another embodiment of the invention which includes a further elastomeric layer.

FIG. 5 shows a protective sheath according to another embodiment of the invention.

The particularity of the drawings listed above and the associated description below does not supersede the generality of the preceding broad description of the invention.

### DETAILED DESCRIPTION OF DRAWINGS

The description of drawings provided below refers primarily to a protective sheath configured to locate about a hose. However, the drawings are intended to be for illustrative purposes only, and it is therefore to be appreciated that the invention is intended for the more general application to a conduit (or conduits) such as, but not limited to, a hose or a pipe. The invention may be used in applications with any practical working pressure as suitable for the particular application required.

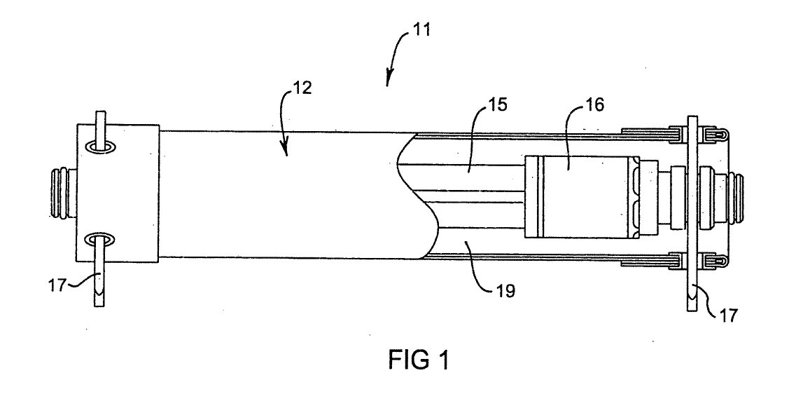

Referring to FIG. 1, a high pressure hose assembly 11 is illustrated including a length of conduit, illustrated herein as hose 15, and a pair of hose couplings 16 (only one of which is illustrated), one at each end of the hose 15. The couplings 16 could adopt any suitable form and need not be of the type illustrated.

The hose assemblies 11 may be used as a hydraulic or pneumatic line, and may contain or transfer a fluid or other working medium, e.g. oil or air, so as to provide a control or power action. It may also be used as a transport line to supply material, e.g. the fluid or working medium itself or material entrained therein, and e.g. may be used as pump lines.

Due to the high pressures that are generally involved, significant safety concerns may arise if the hose 15 in the hose assembly 11 fails. For example, fluid ejected from a burst or damaged hose may splash, spray or mist nearby machinery components or personnel, which may cause a significant fire hazard, or may even be injected into a person under high pressures, causing serious injury or even death. Also, the forces involved in the failure may cause a failure in the assembly at a point at or near a hose anchor or coupling, such that one end of the hose becomes free to whip about violently, causing harm and damage should the free end of the hose strike nearby machinery or personnel.

The present invention provides a protective sheath 12 which aims to mitigate against fluid ejection problems in a damaged or burst hose and to eliminate or at least more effectively restrain any whipping movement occurring in a failed hose assembly.

In the embodiment shown in FIGS. 1 and 3, the protective sheath 12 has two layers, including a woven layer 13 (not illustrated in detail in FIG. 1) and an elastomeric layer 14 (also not illustrated in detail in FIG. 1), that extends along the length of hose 15 in the hose assembly 11, and that is anchored at its ends to hose assembly couplings 16 by anchors 17.

As shown more clearly in FIG. 3, the protective sheath 12 includes two layers, being a woven layer 13 and an elastomeric layer 14, and the sheath 12 is configured to locate around the length of hose 15.

The woven layer 13 of the protective sheath 12 is seamless. A seamless woven layer 13 can advantageously block or hinder the ejection of fluid during a hose burst, although the woven layer 13 need not be fluid tight.

It is to be appreciated that, if required, the woven layer 13 may have a seam which runs substantially along the length of the woven layer 13 of the sheath 12.

The woven layer 13 is made from a substantially closed-weave material (i.e. of closed or continuous form, having substantially no openings or interstices along the length of the woven layer of the sheath 12). It is particularly preferable for the warp and weft yarns to be arranged in a high strength, high density weave pattern. In a preferred embodiment, the woven layer 13 has a high density weave pattern having a coverage of above about 50% to 100%.

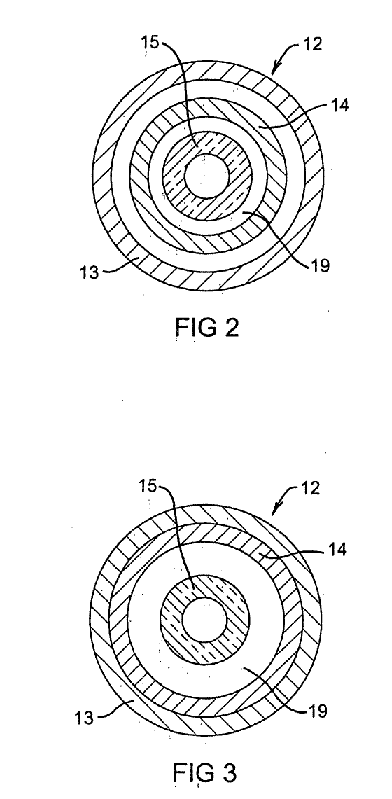

In the embodiment shown in FIG. 2, when fluid is ejected through a rupture point/zone or damaged area of the hose 15, both the separated woven and elastomeric layers 13;14 will move and absorb the energy of the fluid and restrain any resulting movement of the hose 15. If fluid bursts through the innermost layer (elastomeric layer 14), a lot of the fluid force will be dissipated, and further force will be dissipated as the fluid crosses the gap separating the layers 13;14. Thus, when the fluid hits the outer layer (woven layer 13), the fluid force may be greatly reduced, so that the separate outer layer, which will also give or deform under the fluid pressure, will be able to absorb the remaining fluid energy and deflect the fluid along the gap separating the inner and the outer layers, without the outer layer failing.

The woven layer 13 is fixed to the elastomeric layer 14 in the preferred arrangement illustrated in FIGS. 1 and 3. The woven layer 13 may be fixed to the elastomeric layer 14 along the substantial entirety of the mating surfaces between the woven layer 13 and the elastomeric layer 14 (such as when the mating surfaces are defined by an innermost surface of the woven layer 13 and an outermost surface of the elastomer layer 14 as shown in the embodiment in FIG. 3).

The woven layer 13 may be fixed to the elastomeric layer 14 in any suitable manner, including fixing along substantially continuous mating surfaces between the woven layer 13 and the elastomeric layer 14, or may be fixed at any number of discrete fixing points.

Other alternative embodiments of the protective sheath 12 according to the invention which are not shown in the Figures include the elastomeric layer 14 being integral with the woven layer 13, or alternatively in a particularly preferred embodiment being vulcanised to the woven layer 13.

Further alternative embodiments (also not shown in the Figures) include a protective sheath 12 having the elastomeric layer 14 being impregnated into the woven layer 13, or alternatively being bonded (either chemically or physically bonded, as suitable) or adhered to the woven layer 13. The adhesive used to adhere the elastomeric layer 14 to the woven layer 13 can be chosen from any suitable chemical adhesive as would be understood by a person skilled in the art.

The woven and elastomeric layers 13;14 can be positioned relative to one another in any suitable configuration. For example, the woven and elastomeric layers 13;14 of the hose sheath 12 can be positioned relative to one another such that the woven layer 13 defines an inner layer of the sheath 12.

In the embodiment illustrated in FIG. 2, the sheath 12 is configured such that the woven layer 13 is separate from the elastomeric layer 14, although a more preferred arrangement is illustrated in FIGS. 1 and 3.

In other embodiments, the sheath 12 according to the present invention can further include one or more further layers. The one or more further layers can include a further woven layer, or a further elastomeric layer, or combinations thereof, depending on the particular application and characteristics of the sheath required.

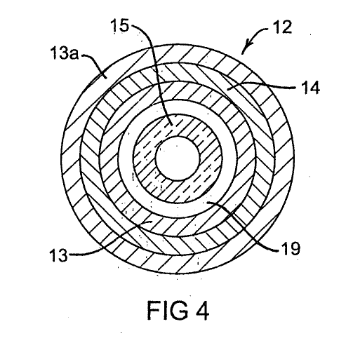

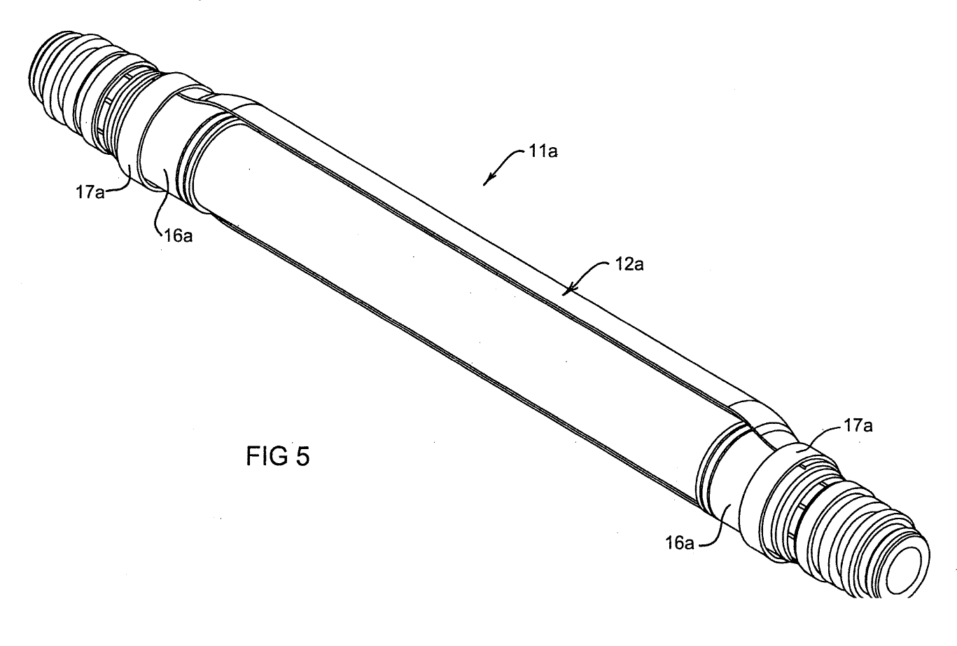

In the embodiment shown in FIG. 4, the one or more further layers includes a further woven layer 13a which is positioned relative to the elastomeric layer 14 such that the further woven layer 13a defines an outer layer of the sheath 12 and the woven layer 13 defines an inner layer of the sheath 12. In this embodiment, it is preferable that both the woven layer 13 and the further woven layer 13a are made from a substantially closed weave material. However any suitable woven material may be made may be used.

It is also understood that while the arrangement of the sheath 12 shown in FIG. 4 illustrates one preferred embodiment of the present invention, any combination of woven and elastomeric layers combined in any number of fixed or separate layers could be used.

While the embodiments shown in the Figures are not to scale, the thickness of the woven layer 13 is preferably between approximately 0.3 mm and approximately 4.0 mm, and more preferably the woven layer 13 thickness is between approximately 1.0 mm and approximately 1.5 mm. The optimum thickness of the woven layer 13 (and any further woven layer(s) 13a), however, will depend on the application for which the protective sheath 12 is used, and may be altered accordingly.

Preferably, the elastomeric layer of the protective sheath is made substantially from rubber or polyurethane, although the elastomeric layer may alternatively, or additionally, be made of an alternative material which has similar material properties to rubber and/or polyurethane. Examples of alternative elastomeric materials suitable for the elastomeric layer may be chosen from, but are not limited to, polyurethane, synthetic rubber, natural rubber, polytetrafluoroethylene (PTFE) (e.g. TEFLON®), fluoroelastomer (e.g. FKM, VITON®), and silicon, or a combination thereof.

Although the embodiments shown in the Figures are not to scale, the thickness of the elastomeric layer 14 is preferably between approximately 0.1 mm and approximately 5.0 mm, and more preferably the elastomeric layer 14 thickness is between approximately 0.3 mm and approximately 2.0 mm. The optimum thickness of the elastomeric layer 14, however, will depend on the application for which the protective sheath is used, and may be altered accordingly.

As shown in the embodiment in FIG. 1, the sheath includes two anchors 17, which can be in the form of staples, cable/eyelet arrangements, or any other suitable anchor arrangement as determined by the person skilled in the art. The anchors 17 are shown as being located at the ends of the sheath 12 to anchor the sheath 12 relative to the hose 15. It will be appreciated, however, that a single anchor 17 could be used which is arranged towards at least one of the end of the sheath 12, or that other anchor arrangements could alternatively, or additionally, be used depending on the requirements of the hose assembly.

Advantageously, the one or more anchors can be arranged such that the sheath 12 can at least partially capture any fluid or other working medium which erupts through a rupture point/zone of the hose 15. Furthermore, the one or more anchors can be arranged in any suitable arrangement which may advantageously minimise or prevent a hose or other form of conduit from whipping if fluid or other working medium erupts through a rupture point/zone of a hose or other form of conduit which is covered by the protective sheath according to the invention.

The one or more anchors 17 may be also anchored to the sheath 12 through one or more anchoring points on the sheath 12, or alternatively the anchors 17 may adopt any other suitable form so as to anchor the sheath 12 relative to the hose 15 of the hose assembly 11 by means of crimping, clamping, heat-shrinking, circlipping, cable tying or swaging, or any other suitable method of anchoring known to a person skilled in the art.

In one embodiment (not shown), the one or more sheath anchors 17 can be positioned to anchor the sheath 12 to an external fixing point (not shown), or to one or more of the hose couplings 16 of the hose assembly 11.

As shown in the embodiments in FIGS. 1 and 2, and 3, the sheath 12 is sized such that there is a gap 19 (i.e. a loose fit) between the sheath 12 and the hose 15. The width of the gap 19 can be advantageously arranged such that if fluid erupts through a rupture point in the hose 15, the protective sheath 12 can dissipate the energy of the erupted fluid, and any fluid which ejects from the hose 15 can be dispelled through the gap 19 and towards or out of the ends of the sheath 12. Furthermore, any reinforcing material contained within the hose 15, such as metal wires etc, which may become exposed at the rupture point can be contained within the gap 19 and not damage or rupture the protective sheath 12. Advantageously, the gap 19 can be arranged as an annular gap.

While the embodiments shown in the Figures are not shown to scale, in a relaxed state the sheath 12 is preferably sized to have an inner diameter that is in excess of about 20% larger than an outer diameter of the hose 15 of the assembly 11. In a particularly preferred embodiment, the inner diameter of the sheath 12 is between about 20% to about 60% larger than the outer diameter of the hose 15 of the assembly 11. Generally, the larger the hose diameter, the larger the ratio of the sheath inner diameter to the sheath outer diameter that is required. However, a sheath with a larger relative outer diameter than the hose outer diameter may be used for applications where the hose (or other form of conduit) is flexible or subject to bending.

In one embodiment (not shown) the sheath 12 length can be arranged to extend over, or past, one or both of hose couplings 16 which are located at or near to the ends of the sheath 12. This can provide the advantage in a situation where a hose assembly 11 fails at or near a coupling 16, and the additional length of the sheath 12 extending over, or past, the hose couplings 16 can allow the sheath to move, flex or deform in response to the pressure applied to the sheath 12 by the ejected fluid or working medium during the failure, whilst still providing at least partial protection in the area of the coupling 16.

Preferably, the sheath 12 has a sheath length which is between about 5% to about 15% longer than the length of hose 15, and more preferably the sheath 12 length is about 8% longer than the length of hose 15 of the assembly 11.

Generally speaking, the greater the coverage provided by the sheath located about the length of hose, the greater the protection that can be provided along the length of hose. Furthermore, when the sheath locates about a substantial proportion of, or a substantially similar length to, the length of hose, any fluid which erupts from a rupture point/zone in the hose can be dispelled further away from the rupture point/zone of the hose 15 towards the ends of the protective sheath 12. This can minimise the spraying, misting or ejection of fluid or other working medium onto nearby machinery or components, and can also reduce the chance of injury to personnel caused by fluid injection or spraying.

FIG. 5 illustrates another hose assembly 11a. The hose assembly 11a is similar in most respects to the assembly 11 illustrated in FIG. 1. One major difference resides in the specific form of the anchors 17a, which are provided in the form of circular clamps. The clamps clamp the ends of the sheath 12a (shown in cross-section) about the couplings 16a.

As discussed previously, the present invention can provide particularly advantageous results when applied to high pressure hydraulic applications, although the sheath of the present invention is applicable to any practical working pressure for any fluid or other foreseeable working medium. For example, the hose can be arranged as a high pressure hose which is rated to a working pressure of about 300 bar or more. Indeed, the hose could have a rated working pressure of up to about 500 bar (or more).

However, the sheath 12/12a according to the invention can also provide significant safety benefits when applied to other applications, such as low pressure and/or pneumatic applications which have hoses rated to work at much lower pressures and which may not experience such spectacular failures in these lower pressure environments.

For example, some low pressure applications use particularly dangerous working mediums such as steam or super-saturated steam, which can cause serious injury to personnel if the conduit conducting the steam fails. In applications using super-saturated steam, pressures may be in the order of about 90 bar, or in non super-saturated steam applications may be conducting relatively low pressures in the order of around 15 bar. Accordingly, the protective sheath of the present invention can provide significant safety benefits when it is configured to locate about a length of hose (or other form of conduit) carrying low pressure working mediums.

It is also envisaged that the sheath 12/12a of the present invention can be configured to locate around more than one length of conduit, such as in applications which may include two conduits, or a bundle of conduits, such that the protective sheath can act as a whip protection or burst suppression sheath, to minimise or eliminate the effects of a rupture or failure in one or more of the conduits.

Whilst not shown in the embodiments, the present invention also provides for a method of forming a protective sheath from a woven layer and an elastomeric layer, the sheath according to any one of the sheath embodiments as described above.

In one non-limiting example, the inner elastomeric layer is extruded to create a seamless tube. A seamless tube sock is woven over the elastomeric tube. The elastomeric layer is pressurised so it expands into the textile weave. The elastomer and textile weave (protective sheath) are vulcanised and the elastomer cures attached to the textile weave.

Those skilled in the art will appreciate that the invention described herein is susceptible to variations, modifications and/or additions other than those specifically described. It is understood that the invention includes all such variations, modifications and/or additions which fall within the spirit and scope of the present invention.

Furthermore, it is understood that the features of the disclosed embodiments may be combined in a number of different ways to create other embodiments which can provide effective burst suppression and/or whipping conduit restraint.

1. A protective sheath, the sheath having at least two layers comprising:
a woven layer; and
an elastomeric layer;
the sheath being configured to locate around a length of conduit.

2. A protective sheath according to claim 1, wherein the woven layer is seamless.

3. A protective sheath according to claim 1, wherein the woven layer has a high density weave pattern having a coverage of between at least about 50% to 100%.

4. A protective sheath according to claim 1, wherein the woven layer is fixed to the elastomeric layer.

5. A protective sheath according to claim 1, wherein the elastomeric layer is integral with the woven layer.

6. A protective sheath according to claim 5, wherein the elastomeric layer is vulcanised to the woven layer.

7. A protective sheath according to claim 5, wherein the elastomeric layer is impregnated into the woven layer.

8. A protective sheath according to claim 5, wherein the elastomeric layer is bonded to the woven layer.

9. A protective sheath according to claim 5, wherein the elastomeric layer is adhered to the woven layer.

10. A protective sheath according to claim 5, wherein the woven layer is impregnated into the elastomeric layer.

11. A protective sheath according to claim 1, wherein the woven layer is separate from the elastomeric layer.

12. A protective sheath according to claim 1, wherein the woven and elastomeric layers are positioned relative to one another such that the woven layer defines an inner layer of the sheath.

13. A protective sheath according to claim 1, wherein the woven and elastomeric layers are positioned relative to one another such that the elastomeric layer defines an inner layer of the sheath.

14. A protective sheath according to claim 1, wherein the sheath comprises one or more further layers.

15. A protective sheath according to claim 14, wherein the one or more further layers comprise at least one further woven layer, at least one further elastomeric layer, or combinations thereof.

16. A protective sheath according to claim 14, wherein the one or more further layers comprises a further woven layer which is positioned relative to the elastomeric layer such that the further woven layer defines an outer layer of the sheath.

17. A protective sheath according to claim 14, wherein the one or more further layers comprises a further elastomeric layer which is positioned relative to the woven layer such that the further elastomeric layer defines an outer layer of the sheath.

18. A protective sheath according to claim 13, wherein the woven layer and one or more of any further woven layers are chemically finished with a continuous dyeing process, whereby the woven layer and the one or more of any further woven layers are dyed with different colours, thus permitting the degree of wear of an outermost woven layer of the sheath to be indicated.

19. A protective sheath according to claim 1, wherein at least one of the layers is metal reinforced.

20. A protective sheath according to claim 1, wherein the woven layer comprises warp and weft yarns made of a synthetic material selected from any one of: polyamide, aramid, polyester, fibreglass, silicon, or a combination thereof.

21. A protective sheath according to claim 1, wherein the woven layer is made from a substantially closed-weave material.

22. A protective sheath according to claim 1, wherein the woven layer is made from a substantially open-weave material.

23. A protective sheath according to claim 1, wherein the woven layer has a thickness of between approximately 0.3 mm and approximately 4.0 mm, and more preferably has a thickness between approximately 1.0 mm and approximately 1.5 mm.

24. A protective sheath according to claim 1, wherein the elastomeric layer is made substantially from any one of: polyurethane, synthetic rubber, natural rubber, polytetrafluoroethylene, fluoroelastomer, silicon, or a combination thereof.

25. A protective sheath according to claim 1, wherein the elastomeric layer has a thickness of between approximately 0.1 mm and approximately 5.0 mm, and more preferably has a thickness between approximately 0.3 mm and approximately 2.0 mm.

26. A protective sheath according to claim 1, wherein the sheath has a sheath reliability, the sheath reliability being met when the sheath satisfies one or more of the following parameters:
a. the sheath can withstand high burst pressure, of about 300 bars or more;
b. the sheath has a high abrasive resistance;
c. the sheath is rated to withstand high temperatures and/or is at least partially flame-resistant;
d. the sheath has an electrical conductivity which is substantially static-free.

27. A protective sheath according to claim 1, wherein the sheath further comprises one or more anchors for anchoring the sheath relative to a length of conduit.

28. A protective sheath according to claim 1, wherein the sheath is configured to locate about more than one lengths of conduit, the more than one lengths of conduit being arranged substantially proximate or adjacent to one another.

29. A conduit assembly, comprising a protective sheath according to claim 1, the sheath being located about at least one length of conduit.

30. A conduit assembly according to claim 29, wherein the sheath is sized such that there is a gap between the sheath and the at least one length of conduit.

31. A conduit assembly according to claim 30, wherein the sheath is sized to have an inner diameter that is about 25% or more larger than an outer diameter of the at least one conduit of the assembly, and more preferably between about 25% to about 50% larger than the outer diameter of the at least one conduit of the assembly.

32. A conduit assembly according to claim 31, wherein the sheath has a sheath length which is between about 5% to about 15% longer than the length of the at least one conduit, and more preferably the sheath length is about 8% longer than the length of the at least one conduit of the assembly.

33. A conduit assembly according to claim 29, wherein each conduit is a high pressure conduit, the high pressure conduit being rated to a working pressure of in excess of about 300 bar.

34. A conduit assembly according to claim 29, further comprising one or more sheath anchors which are arranged in one or more of the following anchor arrangements:
a. wherein the one or more sheath anchors are arranged towards at least one of the ends of the sheath;
b. wherein the one or more sheath anchors anchor the sheath to an external fixing point;
c. wherein the sheath includes one or more anchoring points, to which the one or more anchors are anchored;
d. wherein the one or more sheath anchors anchor the sheath relative to the hose of the assembly by means of crimping, clamping, heat shrinking, cable tying, circlipping or swaging.

35. A method of forming a protective sheath from a woven layer and an elastomeric layer, the sheath according to claim 1.

36. A protective sheath according to claim 1, wherein a spiral layer is substituted for the woven layer.

37. (canceled)
